(19) United States
(12) Patent Application Publication
(10) Pub. No.: US 2010/0121670 A1
(43) Pub. Date: May 13, 2010

(54) METHOD AND SYSTEM FOR FACILITATING SHIPPING

(75) Inventors: Ashish Saxena, Singapore (SG); Supriya Rao Patwardhan, Kuala Lumpur (MY)

Correspondence Address: International IP Law Group, P.O. BOX 691927, HOUSTON, TX, 77269-1927, US

(73) Assignee: Deutsche Post AG, Bonn (DE)

(21) Appl. No.: 12/597,237

(22) PCT Filed: Apr. 27, 2007
(86) PCT No.: PCT/EP07/03755

§ 371 Date: Oct. 23, 2009

(51) Int. Cl. G06Q 50/00; G06F 15/16; G06Q 30/00; G06Q 20/00; G06Q 10/00

(52) U.S. Cl. 705/8; 705/330; 709/206; 705/34

(57) ABSTRACT

There is provided a system and method for facilitating shipping. An exemplary method comprises automatically detecting that a user at a front-end of a computer system has booked a shipping service. The exemplary method also comprises obtaining shipping information associated with the shipping service. The exemplary method additionally comprises, based on the shipping information, automatically scheduling a pick-up service for the shipment being the object of the shipping service and sending an email message or an instant message incorporating the pick-up schedule information to the user.

### CROSS REFERENCE TO RELATED APPLICATION

Pursuant to 35 U.S.C. §371, this application is the United States National Stage Application of International Patent Application No. PCT/EP2007/003755, filed on Apr. 27, 2007, the contents of which are incorporated by reference as if set forth in their entirety herein.

### FIELD OF THE INVENTION

Exemplary embodiments of the present invention relate generally to logistics systems and methods. Such exemplary embodiments may relate to a method and a computer system for facilitating the shipping of goods.

### BACKGROUND

Logistics systems manage the shipments of goods. They comprise a variety of modules integrated with each other to perform various functionalities. For example, they may comprise a purchasing module evaluating proposals for respective shipments of goods and awarding contracts for the shipments. There may be optimization modules analyzing the proposals and informing the purchasing module if an opportunity exists for at least some of the shipments to be consolidated, in which case at least one contract awarded by the purchasing module is for a consolidated group of the shipments. Administration modules may maintain information relating to the status of proposals received and contracts awarded by the purchasing module. A scheduling module may schedule shipments according to the awarded contracts. On base of a shipment management module it is also possible to track the status of shipments awarded by the purchasing module and scheduled by said scheduling module. A financial module may authorize payments according to the status of shipments tracked by the shipment management module which are for example passed between first and second asynchronous clock domains.

A method and a system for updating status information about shipments via email are known from U.S. Pat. No. 6,047,264, which discloses a method for automatically updating the status of a users orders and shipments via email without using a human attendant by creating and sending email messages.

A web-based electronic shipment system is described in U.S. Pat. No. 6,220,509. There is disclosed a parcel trace system, which provides a browser design adapted for one shipping provider and a plurality of users and another browser design adapted for one user and a plurality of shipping providers.

The shipping of mail and parcel items can typically be described in terms of three primary transport legs. In the first leg, a shipping item, e.g. an envelope, a package, etc., is taken from an initial sender's address to a local collection centre of a shipping service provider. In the second leg, the item is transported from the local collection centre to a delivery centre. In the third leg, the item is transported from the delivery centre to its final destination address.

In general, it is possible that multiple shipping service providers may be employed over the three primary transport legs set forth above. For example, a local courier might provide transportation of a package from a business to a national or regional carrier's drop location, thus handling the first leg. The national or regional carrier might then provide service over the second leg, transporting the package from the drop location, possibly through one or more intermediate hubs, to a delivery centre near the destination address. A third shipping entity may then provide delivery over the last leg.

It is also possible that a single shipping service provider may provide service over two or more legs. For example, a local courier might provide service over the first leg by transporting a package from a business or residence to a local post office, where another shipping service provider provides service over the second and third legs. There are shipping entities which provide door to door service on their own.

Some shipping service providers have an established infrastructure for carrying out the second and third legs of the shipping process. These companies are well equipped for sorting, routing and transporting mail and parcel items once the items are received at a collection warehouse.

The first leg, however, requires that the sender either brings the shipment to the collection centre or makes arrangements for a shipping service provider to pick up the item from the initial address. For example, until recently, in order to use the shipping services, one had either to wait for the postman to come on his regularly scheduled delivery rounds, or to carry the shipment to a post office and wait in line to deliver the shipment. To address this issue, some shipping service providers have specialized in picking up shipments from users and transporting them to the addressee's local post office. The shipping service providers thereby provide shipment pick-up from the sender's premises.

In addition to providing pick-up services, shipping service providers are looking for new technology to improve consumer access to shipping services. In these cases, the user may navigate to a web page to request limited pick-up services.

The pick-up process, as it is currently conducted, is cumbersome and costly to the user and the shipper. Unless there are large numbers of packages to be collected from each pick-up point, the cost of picking up shipments from a single user is relatively high for a shipping service provider. Also, for a service provider to optimize its pick-up stops, the user has to follow scheduling restrictions. For example, in order to use pick-up services, the user has to schedule a pick-up time through a web site over the Internet for each pick-up.

These solutions for helping users ship mail and parcels still put a burden on the user, e.g. by necessitating time-consuming user interaction, creating time restrictions and/or demanding higher costs. Therefore, there is a need for an efficient solution to facilitate the process of shipping for the user.

### SUMMARY OF THE INVENTION

In the following description, shipping refers to the transport of any mail or goods using any available transportation method. Shipping typically involves one or more legs of transportation from an origin location to a destination. Terms referring to mail, package, parcel or shipment are interchangeably used to refer to any and all shipped items.

Terms such as a courier, a pick-up service provider and a shipper are used interchangeably herein to refer to a person, a group of persons or a company that carries out the task of transporting a shipment from an initial location to a different location. A method for facilitating shipping according to an exemplary embodiment of the present invention may comprise the following steps:
automatically detecting that a user at a front-end of a computer system has booked a shipping service;
obtaining shipping information associated with said shipping service;
based on said shipping information automatically scheduling a pick-up service for the shipment being object of the shipping service and sending an email message or an instant message incorporating the pick-up schedule information to the user.

The method according to an exemplary embodiment of the invention does not depend on the system and environment of the user or on mobile or fixed devices. The method can work on any device capable of sending and receiving email or instant messages using any of the email users like MS Outlook, Lotus Notes etc. There is a dependency on the email user and not on the hardware.

The method according to an exemplary embodiment of the present invention provides a simple but innovative solution that helps small and medium-sized users to transact with a courier via email. Exemplary embodiments of the present invention provide a tool with a light footprint to receive and send shipping bills, commercial invoices etc. via e-mail.

The solution will also allow the users to arrange for a courier pick-up by providing details of the pick-up location and the time their packages are ready.

A computer system according to an exemplary embodiment of the present invention may determine that a user did not authorize pick-up. In this case the system may execute a given procedure. For example, the computer system may generate an email to notify the sender that a shipping transaction was ordered, but that no pick-up was scheduled. Such an email may include an offer to the user to authorize scheduling of a pick-up, e.g. one-time authorization or continuous authorization. The system may also generate a notification to another intended recipient.

Accurate and timely shipment information is vital to processing the shipments speedily. An exemplary embodiment of the present invention provides a tool that allows users to easily send their shipment information to a shipper. The shipper can receive shipment information via email, opening up a new segment for small and medium category of users who are otherwise difficult to attract with current eCommerce tools. Email is a universal and widely used mode of communication today and none of the known shippers provide this functionality as yet, hence the tool fits an immediate need and gap in the service offering.

Any user with the ability to access his or her email or instant messaging account on any device will be able to use the services. In principle, it is possible to carry out an exemplary embodiment of the invention with other messaging systems as well, e.g. SMS (short message service) or MMS (multimedia messaging service).

In an exemplary embodiment of the present invention, the method comprises a further step of automatically sending an email draft message or an instant draft message incorporating a confirmation message to be sent by the user.

Once a pick-up instruction has been transmitted, a confirmation email message or instant message of the scheduled pick-up may be transmitted automatically to the user.

In a further exemplary embodiment, the method comprises a further step of obtaining said shipping information from a filled in shipping bill form corresponding to the booked shipping service.

In a further exemplary embodiment, the method comprises a further step of communicating said shipping information to a pick-up service provider by email or by instant messaging.

A computer system according to an exemplary embodiment of the present invention may provide the pick-up service provider with the user identification, shipment related information including the current location of the shipment, and mode of shipment, e.g. priority, express, global express, parcel post, or parcel select or any other type of air, ground or sea mode of shipment.

The pick-up instructions may be communicated to a pick-up service provider in a variety of communication formats, e.g. as instant message, email message, SMS, MMS or voicemail message.

If the system determines that a pick-up is to be scheduled, the system may automatically select a method, e.g. telephone, voice message or text messaging for communicating with the courier, and transmit the information directly to the courier. For example, the courier may be notified about the type of goods contained in the shipment, and given a recommendation for pick-up. An example of such recommendation would be to bring sufficient help to carry a shipment, if the weight is too large for one person to handle.

In another exemplary embodiment, the shipping information is communicated directly to a driver of said pick-up service provider.

In this case, the selection of the assigned person based on a number of shipping parameters may be optimized. For example, based on the location of a given driver at a given time, the driver's travel distance may be minimized, and hence the pick-up delay, by selecting the driver closest to the pick-up location.

In a further exemplary embodiment, scheduling said pick-up service comprises accessing pre-existing account information associated with said user.

According to another exemplary embodiment, scheduling said pick-up service comprises verifying a payment for said pick-up service based on billing information in said preexisting account information.

Payment for the pick-up service may be verified through a user's billing account prior to transmission of the pick-up instruction to a pick-up service provider. In the event that a payment transaction fails, user alerts, e.g. a pop-up window, may be used to provide the user with an opportunity to select an alternate payment account or to update the existing account.

At the time of booking the shipping service, the user may elect the form of payment to be applied for pick-up services, and may provide the necessary credit card or debit card billing information. The user is not required to provide new billing information for subsequent services unless there are changes to the billing information.

The user may indicate whether the system has standing authorization to automatically schedule a pick-up and charge the user's account when a shipping order has been placed. The user may select confirmation options, e.g. whether to send pick-up confirmation messages to the user for each scheduled pick-up, and how and where the confirmation messages should be transmitted. The user may also indicate preferences for one or more pick-up parameters. For example, the user may indicate one or more preferred standard pick-up times.

The user may also select additional options beyond those specific to pick-up services. For example, the user may indicate whether the system should automatically send a notification message, e.g. by automatic voice mail or email to the intended recipient, or automatically send the tracking status to the user while the package is being shipped. Exemplary embodiments of the invention may provide any customization related to any service at registration time or at any later time either automatically or per request from a user or shipping provider.

Exemplary embodiments of the invention may be configured such that, by default, the pick-up service is automatically triggered when the user prints a shipping bill.

In a registration process, a user may select a standard time at which a courier normally picks up shipments after a pick-up instruction is issued. For example, pickups are limited to one designated time per day, unless there is a special request. Thus, a courier can develop a consistent daily route, visiting or bypassing a given user's location based on whether a pick-up instruction was logged prior to the time the courier reached the user's location. Any shipment generated after the designated pick-up time on any day may be picked up on the next day at the designated pick-up time.

In addition to an email or another message notification to the courier, a web page available only to the courier may be updated to include the new notification of the pick-up with the detailed information of the shipment including the time and date of the generation of the shipping bill, user information, the shipping service provider, mode of shipment, shipment destination address, cost of shipment and any other pertinent information. The courier may also have an electronic list of pick-up instructions for a current day to which new pick-up messages are appended as they arrive, e.g. as email, instant message or other electronic communication.

A computer system for facilitating shipping according to an exemplary embodiment of the present invention comprises
means for automatically detecting that a user at a front-end of a computer system has booked a shipping service;
means for obtaining shipping information associated with said shipping service;
means for automatically scheduling a pick-up service to obtain the shipment being object of the shipping service based on said shipping information and sending an email message or an instant message incorporating the scheduled pick-up service to the user.

A communication module may provide tools that allow the system to communicate with multiple devices using multiple message formats, e.g. voice mail, text message, etc., that are streamed through multiple communication means. For example, the system may automatically generate a voice message that is communicated to a courier by telephone, in which case the system utilizes the tools of the communication module to communicate with the courier.

In an exemplary embodiment, the computer system comprises means for automatically generating an email draft message or an instant draft message.

In another exemplary embodiment, the computer system comprises means for obtaining shipping information from a filled in shipping bill form.

### BRIEF DESCRIPTION OF THE DRAWINGS

FIG. 1 is a block diagram of a computer system according to an exemplary embodiment of the invention;

FIG. 2 is a flowchart of a process in case that the user request is a pick-up request in accordance with an exemplary embodiment of the present invention;

FIG. 3 is a block diagram of a system in accordance with an exemplary embodiment of the invention; and

FIG. 4 is a block diagram of a pick-up request form as provided in PDF format, according to an exemplary embodiment of the present invention.

### DETAILED DESCRIPTION OF SPECIFIC EMBODIMENTS

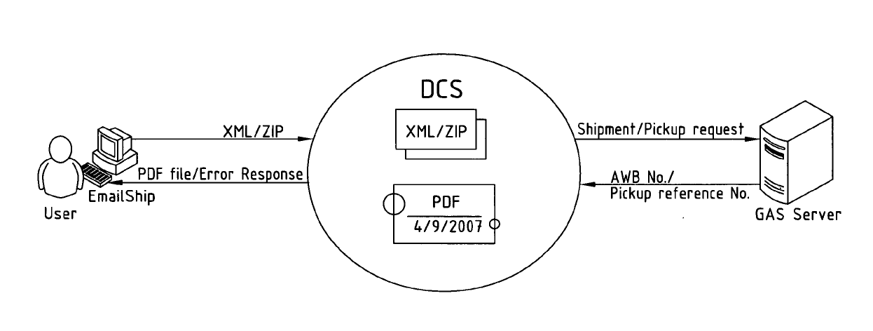

FIG. 1 shows a diagram illustrating an example of a computer system according to an exemplary embodiment of the invention with a user at a front-end displaying a PDF format via email. Data is transmitted in a XML/ZIP format to a back-end comprising a server, namely a GAS. The GAS processes shipment and pick-up requests from the user.

Preferably, a dynamic channel selection (DCS) is implemented in order to increase flexibility.

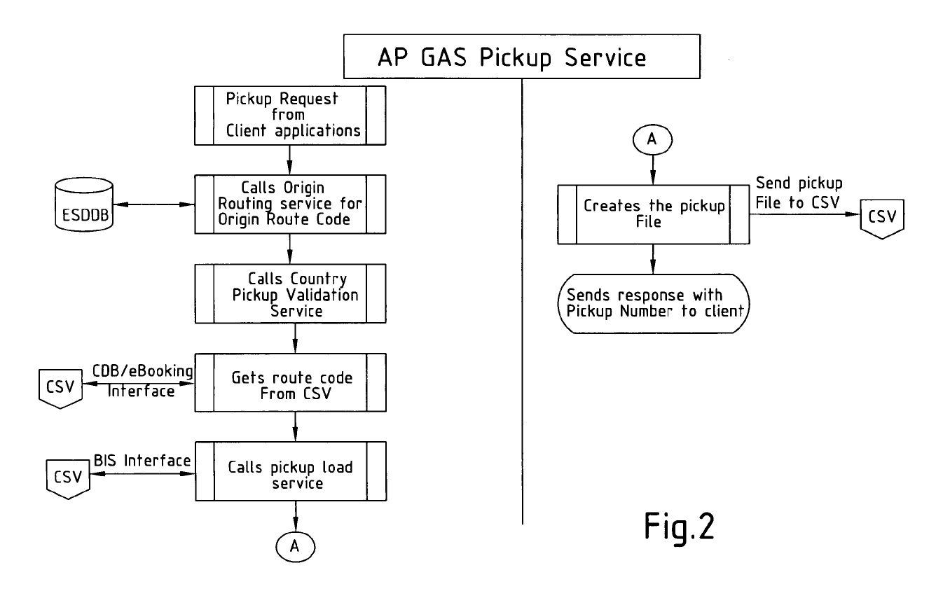

FIG. 2 shows a flowchart illustrating an example of a process in case that the user request is a pick-up request. The GAS in this example is primarily a set of libraries written in C++.

A user application sends a pick-up request.

A database ESDDB calls an origin routing service for an origin route code.

Afterwards, a pick-up validation service is called.

Via a booking interface, a route code is obtained from a cyber service CSV.

Afterwards, the pick-up service calls for a pick-up load service and creates the pick-up file.

Preferably, the pick-up file is send to the cyber service CSV.

Furthermore, the pick-up service sends a response with a pick-up number to the user.

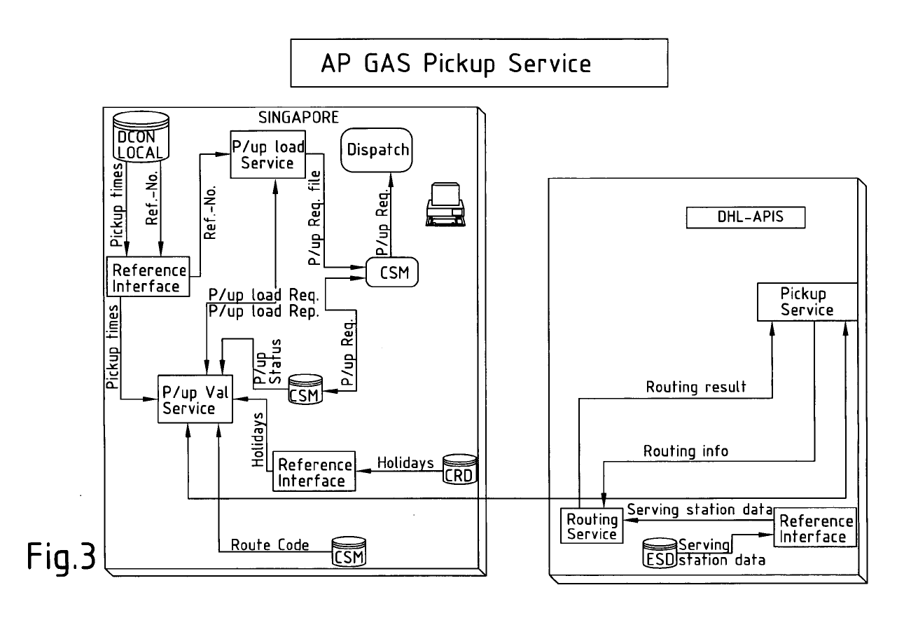

FIG. 3 shows a schematic diagram illustrating a realistic application incorporating an exemplary embodiment of the invention. In an exemplary embodiment the, pick-up service provider is DHL in Singapore.

DHL is a preferred provider of logistics system. The logistics system includes handling objects and preferably additional functionality as for example routing services or load services and/or dispatch information.

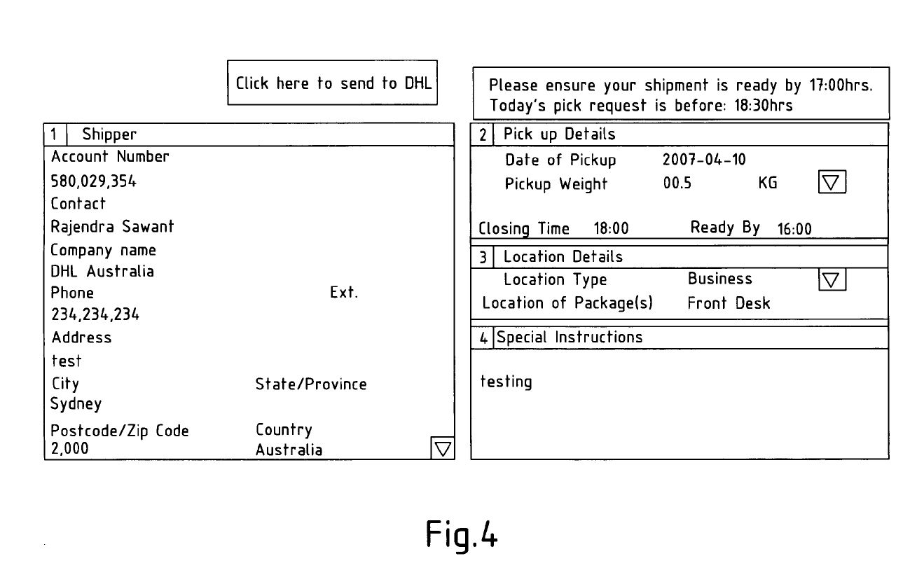

FIG. 4 shows an example of a pick-up request form as provided in PDF format.

The PDF format is of course only one exemplary implementation of a suitable format for transmitting the information.

Exemplary embodiments of the present invention described herein are set forth in terms of methods and computer systems implementing those methods. It will be apparent, however, to one with ordinary skill in the art that an exemplary embodiment of the invention may be implemented as computer software, e.g. computer program code, capable of being stored in a computer memory and executed by a microprocessor.

Each component or module of the computer system may be implemented as part of a larger infrastructure, e.g. within an application server, or as one or more plug-in programs, applets, dynamically loaded libraries, or any other configuration that allows programs to run on one or more computers in order to provide shipping information management. The programs may be embedded within, or interfaced with third party applications. Although described in modular terms for purposes of illustration, exemplary embodiments of the invention need not be limited to modular implementations. The functionality described herein may be implemented in software and/or hardware as a single process or as a combination of multiple processes and/or applications.

Additional components of the computer system may reside in a server that users are able to access remotely using, for example, web browser software such as Internet Explorer or Netscape Navigator. Exemplary embodiments of such computer systems may also include a user application that executes on the user's computer. The user application may execute as a separate process, or as a helper application that extends a web browser's capabilities and enables the latter to communicate with the computer system. The user application may collect certain data related to shipping transactions from the user's computer, and detect such transactions when the user fills in a shipping bill form.

The user may register with the computer system to provide information such as the user's address, user billing information, e.g. credit card information, and user shipping preferences. Subsequent to registration, the user may access the system using authentication methods, e.g. user identification and password parameters.

One or more exemplary embodiments of the invention work with and/or in support of third party shipping and mailing software tools. For example, the user application may be automatically activated when the user prints a shipping bill form. As part of the shipping bill form printing process, the user provides transaction-specific information about the shipment, such as the selected class of shipping, the destination address, the weight and/or size of the package(s), etc. Further transaction-specific information, e.g. value, corrected address, etc. may be derived by the back-end of the computer system based on the user's information.

While example embodiments are described herein, the various aspects of the present invention may be used with various types of computer systems, generally including all system designs which link together disparate processing units such as computers, servers, peripherals, storage devices, and devices for data communications. Examples of such computer systems may include a local area network (LAN), a wide area network (WAN), a metropolitan area network (MAN), and a global area network (GAN).

The example embodiments concentrate mainly on an Internet/XML solution, although the scope of the present invention is not limited thereto. A wide variety of implementations, arrangements and configurations of terminals, switches and links in all types of data networks may be utilized.

The computer system according to an exemplary embodiment of the invention may include a plurality of component modules. These software component modules may be either commercially available off-the-shelf software, customized software or independently developed software. For example, freight rate databases are commercially available. If they are robust and capable of integration with other software components to accomplish the workflows described below, then they can be utilized in the computer system.

The computer system may be centralized in one or relatively few locations or may be distributed throughout a relatively large number of locations. As will be made clear below, each physical shipment represents a plurality of different related work process flows, such as a shipment offer, a shipment acceptance, a customs clearance, in the system. Furthermore the duty to be paid for a shipment may be calculated in various phases of the plurality of different related work process flows.

Other features of an exemplary embodiment of the invention may be apparent to those skilled in the art from the detailed description of the example embodiments and claims when read in connection with the accompanying drawings. While the foregoing and following written and illustrated disclosure focuses on disclosing example embodiments of the invention, it should be understood that the same is by way of illustration and example only, is not to be taken by way of limitation and may be modified in learned practice of the invention. While the foregoing has described what are considered to be example embodiments of the invention, it is understood that various modifications may be made therein and that the invention may be implemented in various forms. The invention is defined by the claims and their full scope of equivalents.

### REFERENCE LIST

DCS dynamic channel selection
AWB air way bill GAS generic application server
ESDDB database
CSV Cyber Services
BIS business information system
DCON display controller P/up pick-up
CSM user service management
CRD Common Reference Database
ESD electronic software distribution

1. A method for facilitating shipping, comprising:
automatically detecting that a user at a front-end of a computer system has booked a shipping service;
obtaining shipping information associated with the shipping service; and
based on the shipping information, automatically scheduling a pick-up service for the shipment being the object of the shipping service and sending an email message or an instant message incorporating the pick-up schedule information to the user.

2. The method according to claim 1, comprising automatically sending an email draft message or an instant draft message incorporating a confirmation message to be sent by the user.

3. The method according to claim 1, comprising obtaining said shipping information from a filled in shipping bill form corresponding to the booked shipping service.

4. The method according to claim 1, comprising communicating said shipping information to a pick-up service provider by instant messaging or by email.

5. The method according to claim 4, wherein said shipping information is communicated directly to a driver of said pick-up service provider.

6. The method according to claim 1, wherein scheduling said pick-up service comprises accessing pre-existing account information associated with said user.

7. The method according to claim 1, wherein scheduling said pickup service comprises verifying a payment for said pick-up service based on billing information in said pre-existing account information.

8. A system for facilitating shipping, comprising
means for automatically detecting that a user at a front-end of a computer system has booked a shipping service;
means for obtaining shipping information associated with said shipping service; and
means for automatically scheduling a pick-up service to obtain the shipment being object of the shipping service based on said shipping information and sending an email message or an instant message incorporating the scheduled pick-up service to the user.

9. The system according to claim 8, wherein the computer system comprises means for automatically generating an email draft message or an instant draft message.

10. The system according to claim 8, wherein the computer system comprises means for obtaining shipping information from a filled in shipping bill form.

11. A system for facilitating shipping, comprising
a detector that is adapted to detect that a user at a front-end of a computer system has booked a shipping service;
an input device that obtains shipping information associated with said shipping service; and
a scheduler that is adapted to schedule a pick-up service, to obtain the shipment being the object of the shipping service based on said shipping information and to send an email message or an instant message incorporating the scheduled pick-up service to the user.

12. The system according to claim 11, wherein the computer system is adapted to automatically generate an email draft message or an instant draft message.

13. The system according to claim 11, wherein the computer system is adapted to obtain shipping information from a filled in shipping bill form.
